(19) United States
(12) Patent Application Publication
(10) Pub. No.: US 2021/0141103 A1
(43) Pub. Date: May 13, 2021

(54) BACKSCATTER DETECTION MODULE

(71) Applicants: Nuctech Company Limited, Beijing (CN); TSINGHUA UNIVERSITY, Beijing (CN)

(72) Inventors: Qingjun ZHANG, Beijing (CN); Yuanjing LI, Beijing (CN); Ziran ZHAO, Beijing (CN); Lifeng SUN, Beijing (CN)

(73) Assignees: Nuctech Company Limited, Beijing (CN); TSINGHUA UNIVERSITY, Beijing (CN)

(21) Appl. No.: 16/624,753

(22) PCT Filed: May 29, 2018
(86) PCT No.: PCT/CN2018/088832

§ 371 Date: Dec. 19, 2019

(30) Foreign Application Priority Data
Jun. 20, 2017 (CN) 201710469197.7

(51) Int. Cl. G01T 1/20

(52) U.S. Cl. CPC G01T 1/20185; G01N 23/203; G01T 1/2006

(57) ABSTRACT

A backscatter detection module includes: a plate-like light-transmitting carrier, two layers of scintillators and a light sensor. The light-transmitting carrier is made of a material that allows fluorescence photons to pass through, and has two light-transmitting planes opposite to each other and at least one light emergent end surface; the light emergent end surface is located between the two light-transmitting planes; the two layers of scintillators are respectively fixedly attached to the two light-transmitting planes; the light sensor is coupled to the light emergent end surface.

### CROSS-REFERENCE

This application claims priority to Chinese Patent Application No. 201710469197.7, filed on Jun. 20, 2017, the entire contents of which are incorporated herein by reference.

### TECHNICAL FIELD

The present disclosure relates to a detection module, and in particular to a backscatter detection module for detecting backscattered X-rays.

### BACKGROUND

At present, existing backscatter detectors convert back-scattered X-rays into fluorescent photons by using scintillators, and then the fluorescent photons are collected by the light sensor and outputted after being converted into electrical signals. Considering the characteristics of backscattered X-rays, if the detection efficiency and sensitivity of backscattered X-rays are to be improved, the backscatter detector must have a sufficiently large sensitive area. The general method is to equip a number of large-area backscatter detectors at both sides of the pen-shaped beam of the scanning imaging system.

In order to improve the performance of the backscattered X-rays system, the scintillator that generates fluorescent photons must have low afterglow, high X-ray absorptivity, and high light conversion efficiency, and has a luminescence spectrum matching the spectral response of the light sensor. Typically, scintillator materials used in backscattering detectors that meet the requirements are generally classified into two types, namely powder screen (such as GOS (Gd₂O₂SO₄) and barium fluochloride) and transparent crystal. Powder screen scintillators generally have low afterglow and high light conversion efficiency, but low density, which results in low absorption efficiency of backscattered X-rays. Also, because of its low light transmittance, powder screen scintillators can only use thin layers. Transparent crystal scintillators generally have high light conversion efficiency and high absorption efficiency of back-scattered X-rays, but their high cost and difficulty in making large-area processes limit their use in back-scattering.

In addition to scintillators used in backscatter detectors, backscatter detectors typically use scintillator films, and then use photomultiplier tubes as photoelectric conversion devices. Such backscatter detectors are large in size, inconvenient to assemble, and have poor seismic performance and low detection efficiency.

It should be understood that information disclosed in the background section above is only for enhancing the comprehension of the background of the present disclosure, and thus may include information that does not constitute prior art known to those ordinary skilled in the art.

### SUMMARY

The purpose of the present disclosure is to overcome the above-mentioned shortcomings of the related art and provide a backscatter detection module with high detection efficiency and compact structure.

Additional aspects and advantages of the present disclosure will be set forth partially in the following description, and will become apparent partially from the description, or may be learned through the practice of the present disclosure.

According to one aspect of the present disclosure, a backscatter detection module includes a plate-shaped light-transmitting carrier, two layers of scintillators, and a. light sensor. The light-transmitting carrier is made of a material that allows fluorescence photons to pass through, and has two light-transmitting planes opposite to each other and at least one light emergent end surface, wherein, the light emergent end surface is located between the two light-transmitting planes, the two layers of scintillators are respectively fixedly attached to the two light-transmitting planes, and the light sensor is coupled to the light emergent end surface.

According to an embodiment of the present disclosure, there are stacked a plurality of the light-transmitting carriers, the two light-transmitting planes of each light-transmitting carrier are provided with a layer of the scintillator.

According to an embodiment of the present disclosure, the light-transmitting carrier is an integral rectangular plate.

According to an embodiment of the present disclosure, the light-transmitting carrier includes two triangular prisms, each of the two triangular prisms has a total reflection surface and a light emergent end surface, and the two total reflection surfaces are bonded to each other so that the two triangular prisms form a cuboid structure, and a light sensor is provided on each of the two light emergent end surfaces.

According to an embodiment of the present disclosure, the light-transmitting carrier includes a plurality of round or square optical fibers arranged side by side, the optical fibers are optically bonded to the scintillator, and end surfaces of the optical fibers are optically bonded to the light sensor.

According to an embodiment of the present disclosure, the end surface of each optical fiber is connected to one light sensor.

According to an embodiment of the present disclosure, the optical fibers are stretched and fused into one body to form the light emergent end surface.

According to an embodiment of the present disclosure, the plurality of optical fibers are bundled into one optical fiber bundle, and an end surface of the optical fiber bundle is modified to form the light emergent end surface and is connected to the light sensor.

According to an embodiment of the present disclosure, the optical fiber is a wavelength-shifting fiber.

According to an embodiment of the present disclosure, the backscatter detection module further includes a metal case with a lower opening and a PCB for covering the opening, wherein, the PCB is provided with a hard supporting structure for supporting the scintillator located on a bottom layer; an elastic material for crimping the scintillator located on a top layer is provided at top of an inner surface of the metal case; and a. sealing ring is provided between the PCB and the metal case.

According to an embodiment of the present disclosure, the sealing ring and the hard supporting structure are formed in one structure.

According to an embodiment of the present disclosure, an auxiliary supporting mechanism for supporting the scintillator is provided between the hard supporting structure and the scintillator.

According to an embodiment of the present disclosure, the inner surface of the metal case is subjected to a light-shielding treatment or is coated with a reflection layer.

According to an embodiment of the present disclosure, the light sensor is a photomultiplier tube or a silicon photodiode.

According to an embodiment of the present disclosure, all exposed surfaces of the scintillator and the light-transmitting carrier are mirror-polished or coated with a reflection layer.

According to an embodiment of the present disclosure, the two layers of the scintillators are made of different materials.

According to an embodiment of the present disclosure, the material of the scintillator on each of the light-transmitting carriers is different from each other.

According to an embodiment of the present disclosure, a filter is provided between two adjacent light-transmitting carriers.

As can be seen from the above technical solutions, the advantages and positive effects of the present disclosure are as follows.

According to the backscatter detection module of the disclosure, two layers of scintillators and a light-transmitting carrier are used for absorbing X-rays, thereby greatly improving the detection efficiency of the backscatter detection module. According to the detection module, the light-transmitting carrier is used as a light-guide material, and a light sensor is provided at the end surface, such that the light-transmitting carrier is able to transmit fluorescent photons and change the light path. Thus, the thickness of the backscatter detector is greatly reduced.

### BRIEF DESCRIPTION OF THE DRAWINGS

The above and other features and advantages of the present disclosure will become more apparent through the detailed description of exemplary embodiments thereof with reference to the accompanying drawings.

FIG. 1 is a structural schematic diagram of a backscatter detection module according to an embodiment 1 of the present disclosure;

FIG. 2 is a structural schematic diagram illustrating a packaged state of the backscatter detection module shown in FIG. 1;

FIG. 3 is a schematic diagram illustrating the use of the backscatter detection module shown in FIG. 1;

FIG. 4 is a structural schematic diagram of a backscatter detection module according to embodiment 2 of the present disclosure;

FIG. 5 to FIG. 10 are structural schematic diagrams of the backscatter detection module according to embodiment 3 of the present disclosure.

### REFERENCE NUMERALS IN THE DRAWINGS

1, 211,212: Scintillator;

2, Light-transmitting carrier;

221,222: Triangular prism;

3, 231, 232: Light sensor;

4, Elastic material;

5, Hard supporting structure;

6, PCB;

7, Sealing ring;

8, Metal case;

9, Protective cover;

10, Backscatter detection module;

11, X-ray source;

12, Object;

13, X-ray beam;

14, Backscatter X-ray.

### DETAILED DESCRIPTION

Exemplary embodiments will now be described more fully with reference to the accompanying drawings. However, the exemplary embodiments may be embodied in many forms and should not be construed as limited to the method of implementation set forth herein; rather, these embodiments are provided so that this disclosure will be thorough and complete, and will fully convey the concept of the exemplary embodiments to those skilled in the art. The same reference numerals in the drawings represent the same or similar parts, so the detailed description thereof will be omitted.

### Embodiment 1

As shown in FIG. 1 to FIG. 3, an embodiment of the present disclosure discloses a backscatter detection module, which includes a light-transmitting carrier 2, two layers of scintillators 1. and a light sensor 3. The two layers of scintillators 1 emit fluorescent photons after receiving. X-rays. The structure of the scintillator 1 is a large-area thin plate with a thickness of about 0.2 mm to 0.8 mm, and preferably 0.3 mm to 0.5 mm. The light-transmitting carrier 2 is also plate-shaped. More specifically, the light-transmitting carrier 2 is an integral rectangular plate, the upper and lower surfaces of which are large planes, and the overall thickness may be about 5 mm. The light-transmitting carrier 2 is made of a material that is transparent relative to the fluorescent photons generated by scintillator 1. In other words, the material selected for the light-transmitting carrier 2 has good photoconductivity to the fluorescent photons, such as PC (Polycarbonate), PMMA (polymethyl methacrylate), quartz glass or polystyrene.

The light-transmitting carrier 2 has two light-transmitting planes opposite to each other and at least one light emergent end surface, and the light emergent end surface is located between the two light-transmitting planes. In FIG. 1, the upper surface and the lower surface of the light-transmitting carrier I are light-transmitting planes, and the end surface on the right side thereof is a light emergent end surface. The two layers of scintillators 1 are fixedly attached to the two light-transmitting planes respectively, and the light sensor 3 is coupled to the light emergent end surface. The side length of the light-sensitive surface of the light sensor 3 is equal to the sum of the side thickness of the scintillator 1 and the light-transmitting carrier 2, so that more fluorescent photons may be received. In FIG. 1, the light sensor 3 is directly attached to the light emergent end surface, so the light sensor 3 is directly coupled to the light emergent end surface. In other embodiments of the present disclosure described later, the light sensor 3 may also be indirectly coupled to the light emergent end surface. The scintillator 1 and the light-transmitting carrier 2 may be connected by being directly crimped, or optically bonded using an adhesive with good light transmittance.

The light sensor 3, which is used for photoelectric conversion, converts fluorescent photons into electrical signals. The specific type of the light sensor 3 is not limited. For example, the light sensor 3 may be a photomultiplier tube (PMT) or a silicon photomultiplier tube (SiPM), and the latter is preferably used. Compared with ordinary photodiodes, silicon photomultiplier tubes have an amplification factor of about 10⁵ and a signal response in nanosecond time scale. Compared with the traditional photomultiplier tube, which has high amplification factor and fast response, the negative feedback Geiger mode of the silicon photomultiplier tube is safer for strong light pulses and easier to operate. The high output signal level is not only beneficial to improve the sensitivity of the detector, but also beneficial to increase the detector's ability of anti-interference and anti-environmental change. In addition, the silicon photomultiplier tube is much smaller than the traditional photomultiplier tube, thereby achieving a compact structure of the entire backscatter detector. The silicon photomultiplier tube, which is installed on the side of the scintillator 1 and the light-transmitting carrier 2, is small in size, and therefore may not cause a large change to the blind spot (the area not covered by the scintillator 1 when multiple detectors are installed side by side).

As can be seen from FIG. 1, in this embodiment, the scintillator 1 and the light-transmitting carrier 2 constitute a “three-layer sandwich” structure. After the backscattered. X-rays reflected from the scanned object interact with the first layer of scintillator 1 located in the upper part in FIG. 1, the generated fluorescent photons penetrate the interface where the scintillator 1 and the light-transmitting carrier 2 intersect with each other and enter into the light-transmitting carrier 2. These fluorescent photons are finally collected by the light-sensitive surface of the light sensor 3 after several reflections in the light-transmitting carrier 2. The arrows in FIG. 1 indicate the travel paths of X-rays and fluorescent photons. It can be seen from FIG. 1 that when some of the X-rays are not absorbed by the scintillator in the upper layer in FIG. 1, these X-rays penetrate the light-transmitting carrier 2, reach the second layer of scintillator located below the light-transmitting carrier 2 that is in the lower part in FIG 1, and interact with the second layer of scintillator and generate fluorescent photons. In this way, the X-ray absorption efficiency may be significantly improved, and the X-ray detection efficiency may be improved accordingly.

Further, the scintillator 1 and the light-transmitting carrier 2 in this embodiment may also be made into a structure with more layers such as “five-layer sandwich” and “seven-layer sandwich”. In other words, a plurality of light-transmitting carriers 2 may be provided in a stacking way, and two light-transmitting planes of each light-transmitting carrier 2 may be attached with a layer of scintillator. The light-transmitting carriers 2 mentioned here indicate that the number of the light-transmitting carrier 2 is two or more. As the number of the light-transmitting carrier 2 increases, sonic of the X-rays will enter into another light-transmitting carrier after passing through one light-transmitting carrier, thereby further improving the absorption and detection efficiency of X-rays. In addition, the two layers of scintillators 1 on both sides of the light-transmitting carrier 2 may be made of different materials. For example, the upper layer of the scintillator may be the GOS film and the lower layer may be the plastic scintillator. In this way, different types of scintillators may be used to detect the low-energy and high-energy part of the X-rays.

A more preferred manner is to adopt multiple groups of the above-mentioned “sandwich” structure, that is, on the basis of multiple stacked light-transmitting carriers, different materials may be selected for the scintillator of each light-transmitting carrier. For example, the scintillator of the first light-transmitting carrier may be the GOS film, and the scintillator of the second light-transmitting carrier may be the plastic scintillator. Through setting the scintillators of different materials, one or more upper groups of light-transmitting carriers may be used for detecting the low-enemy part of the backscattered X-rays, while the one or more lower groups of light-transmitting carriers may be used for detecting the high-energy part of the backscattered X-rays. These light-transmitting carriers collectively form a dual-energy detector. The light-transmitting carriers may be divided into multiple groups to form a multi-energy detector for substance identification. The multiple light-transmitting carriers may be pressed together, or a certain gap may be left between each other.

Furthermore, a filter may be provided between two adjacent light-transmitting carriers, so as to allow specific X-rays to enter into the light-transmitting carriers, thereby achieving better effect of the substance identification. The filter and the light-transmitting carrier may be pressed together, or a certain gap may be left between each other.

Referring to FIGS. 2 and 3, in this embodiment, the backscatter detection module further includes a metal case 8 and a PCB 6. The metal case 8 is manufactured by a stretching process, which may prevent the entrance of external rays (such as cosmic rays and scattered rays), The metal case 8 has an opening in the lower portion, and the PCB 6 is used for covering the opening. The scintillator 1 and the light-transmitting carrier 2 are placed inside the metal case 8. The inner surface of the metal case 8 is subjected to a light-shielding treatment or is coated with a reflection layer to avoid interference from non-backscattered X-rays as much as possible. An elastic material 4 for crimping the scintillator on the top layer is provided on the top position of the inner surface of the metal case 8, and a hard supporting structure 5 is provided on the PCB 6 to support the scintillator on the bottom layer. A sealing ring 7 is provided between the PCB 6 and the metal case 8. After the PCB 6 is installed, the PCB 6 and the metal case 8 squeeze the scintillator at the upper and lower sides, so as to ensure the stability of the scintillator I and the light-transmitting carrier 2 and avoid their movement. The sealing ring 7 and the hard supporting structure 5 may be configured as one structure, that is, the hard supporting structure 5 has the dual function of supporting and sealing at the same time. The hard supporting structure 5 generally supports both ends of the scintillator 1, and an auxiliary supporting mechanism for supporting the scintillator 1 may be provided between the hard supporting structure 5 and the scintillator 1. The auxiliary supporting mechanism may provide supporting to the middle position of the scintillator, making the scintillator more stable, In use, the incident surface may also be selected according to the energy level of backscattered X-rays. When the energy of the backscattered X-rays is high, the metal case 8 may be used as the incident surface, which may effectively protect the detector elements such as scintillator and light-transmitting carrier. When the energy of the backscattered X-rays is low, the PCB may be used as the incident surface, so as to improve the detection efficiency. All exposed surfaces of the scintillator and the light-transmitting carrier are mirror-polished or coated with a reflection layer, so that the path of fluorescent photons is confined inside the scintillator, the light-transmitting carrier and the light sensor as much as possible.

Referring to FIG. 3, the process of using the backscatter detection module in this embodiment is as follows. The X-ray source 11 emits an X-ray beam 13 which is directed at the object 12 and generates backscattering on the object 12. The backscattered X-rays 14 is emitted from the surface of the object to the surroundings. Two backscatter detection modules 10 of the present disclosure are disposed on both sides of the X-ray source 11. These two backscatter detection modules convert the backscattered X-ray 14 into electrical signals for subsequent electronic devices to analyze and process.

The backscatter detection module of the present disclosure uses at least two layers of scintillators 1 and a light-transmitting carrier 2 to absorb X-rays, which greatly improves the detection efficiency. In combination with a multilayer scintillator combination, the detection efficiency may he greatly improved, or dual-energy detection (multi-energy detection) may be realized for substance identification. According to the detection module, the light-transmitting carrier is used as a light-guide material, and a light sensor is provided on the end surface, such that the light-transmitting carrier is able to transmit fluorescent photons and change the light path, thus, the thickness of a backscatter detector is greatly reduced. The detection module further uses a silicon photomultiplier tube (SiPM) as a light sensor, which may further reduce the volume and reduce the dead zone of the detection. This detection module adopts a modular structure, which is modular in structure and shock resistance. It has a compact structure, convenient installation, strong shock resistance, and may effectively block external interference and visible light. The detection module may select different incident surfaces according to the energy level of backscattered X-rays, which may effectively protect the detector elements and increase the depth of backscatter penetration as much as possible.

### Embodiment 2

As shown in FIG. 4, the structure of the backscatter detection module disclosed in the embodiment of the present disclosure is basically the same as that of the embodiment 1, and also includes a light-transmitting carrier, two layers of scintillators, and a light sensor. The difference between this embodiment and the embodiment 1 is that the light-transmitting carrier includes two triangular prisms 221 and 222, and each of the triangular prism 221 and the triangular prism 222 has a total reflection surface and a light emergent end surface. The two total reflection surfaces are bonded together so that the two triangular prisms 221 and 222 form a cuboid structure. A light sensor 231 is provided on the light emergent end surface of the triangular prism 221, and a light sensor 232 is provided on the light emergent end surface of the triangular prism 222. The fluorescent photons generated by the scintilla tor 211 are reflected by the total reflection surface of the triangular prism 221 and then reach the light sensor 231. The fluorescent photons generated by the scintillator 212 are reflected by the total reflection surface of the triangular prism 222 and then reach the light sensor 232,

### Embodiment 3

Referring to FIGS. 5 to 10, the same part concerning backscatter detection module between this embodiment and the embodiments 1 and 2 will not be described here, and the difference is that the light-transmitting carrier 2 in this embodiment includes multiple round or square fibers disposed side by side. FIG. 5 shows the front view of the arrangement of round optical fibers, FIG. 6 shows the front view of the arrangement of square optical fibers, and FIG. 7 shows the left view of the optical fibers shown in FIGS. 5 and 6 when they are arranged. In this embodiment, the optical fibers are arranged in a plate shape. The optical fibers are optically bonded to the scintillator 1, and the end surfaces of the optical fibers are optically bonded to the photosensitive surface of the light sensor 3. The remaining surfaces of the optical fibers may be coated with a reflection layer so that fluorescent photons may only reach the light sensor through the fiber.

FIG. 8 shows a schematic diagram of the processing of the optical fiber. As shown in FIG. 8, each optical fiber may be connected to the light sensor 3 independently, or the optical fibers may be stretched and fused into one body to form an integral light emergent end surface, and then connected to the light sensor 3. In addition, FIG. 9 is a schematic diagram of bundling optical fibers. As shown in FIG. 9. optical fibers in the light-transmitting carrier 2 may be bundled into one optical fiber bundle, and the end surface of this optical fiber bundle is connected to the light sensor 3 at the end far from the scintillator 1 after being modified. FIG. 10 is a schematic diagram of fixing the optical fiber to a metal case. As shown in FIG. 10, when the optical fibers are located in the metal case 8, a corresponding protective cover 9 may be provided on the PCB 6 to protect and limit the light sensor 3 and prevent it from shaking.

When the light-transmitting carrier 2 is optical fiber, multiple optical fibers may be spliced together, so as to achieve a large-area light-transmitting carrier 2 and reduce the costs at the same time. The optical fiber may be the wavelength-shifting fiber, so that the fluorescence spectrum generated by the scintillator matches the spectral response of the light sensor.

The exemplary embodiments of the disclosure have been shown and described in detail as above. it should be understood that the disclosure is not limited to the disclosed embodiments, but is intended to cover various modifications and equivalent arrangements included within the spirit and scope of the appended claims.

1. A backscatter detection module, comprising:
a plate-shaped light-transmitting carrier, made of materials that allow fluorescence photons to pass through, and having two light-transmitting planes opposite to each other and at least one light emergent end surface, the light emergent end surface being located between the two light-transmitting planes;
two layers of scintillators, respectively fixedly attached to the light-transmitting planes; and
a light sensor, coupled to the light emergent end surface.

2. The backscatter detection module of claim 1, wherein there are stacked a plurality of the light-transmitting carriers, the two light-transmitting planes of each light-transmitting carrier are provided with a layer of the scintillator.

3. The backscatter detection module of claim 1, wherein the light-transmitting carrier is an integral rectangular plate.

4. The backscatter detection module of claim 1, wherein the light-transmitting carrier comprises two triangular prisms, and each of the two triangular prisms has a total reflection surface and a light emergent end surface, and the two total reflection surfaces are bonded to each other, causing the two triangular prisms to form a cuboid structure, and each of the two light emergent end surfaces is provided with a light sensor.

5. The backscatter detection module of claim 1, wherein the light-transmitting carrier comprises a plurality of round or square optical fibers arranged side by side, the optical fibers are optically bonded to the scintillator, and end surfaces of the optical fibers are optically bonded to the light sensor.

6. The backscatter detection module of claim 5, wherein the end surface of each optical fiber is connected to one light sensor.

7. The backscatter detection module of claim 5, wherein the optical fibers are stretched and fused into one body to form the light emergent end surface.

8. The backscatter detection module of claim 5, wherein the plurality of optical fibers are bundled into one optical fiber bundle, and an end surface of the optical fiber bundle is modified to form the light emergent end surface and is connected to the light sensor.

9. The backscatter detection module of claim 5, wherein the optical fiber is a wavelength-shifting fiber.

10. The backscatter detection module of claim 1, further comprising: a metal case with a lower opening and a PCB for covering the opening, wherein the PCB is provided with a hard supporting structure for supporting the scintillator located on a bottom layer; an elastic material for crimping the scintillator located on a top layer is provided at top of an inner surface of the metal case; and a sealing ring is provided between the PCB and the metal case.

11. The backscatter detection module of claim 10, wherein the sealing ring and the hard supporting structure are formed in one structure.

12. The backscatter detection module of claim 11, wherein an auxiliary support mechanism for supporting the scintillator is provided between the hard supporting structure and the scintillator.

13. The backscatter detection module of claim 10, wherein the inner surface of the metal case is subjected to a light-shielding treatment or is coated with a reflection layer.

14. The backscatter detection module of claim 1, wherein the light sensor is a photomultiplier tube or a silicon photodiode.

15. The backscatter detection module of claim 1, wherein all exposed surfaces of the scintillator and the light-transmitting carrier are mirror-polished or coated with a reflection layer.

16. The backscatter detection module of claim 1, wherein the two layers of the scintillators are made of different materials.

17. The backscatter detection module of claim 2, wherein the material of the scintillator on each of the light-transmitting carriers is different from each other.

18. The backscatter detection module of claim 17, wherein a filter is provided between two adjacent light-transmitting carriers.
